(19) United States
(12) Patent Application Publication
(10) Pub. No.: US 2024/0064191 A1
(43) Pub. Date: Feb. 22, 2024

(54) WIRED AND WIRELESS SWITCHING FOR HEAD-MOUNTED DEVICE

(71) Applicant: Universal City Studios LLC, Universal City, CA (US)

(72) Inventor: Patrick John Goergen, Orlando, FL (US)

(21) Appl. No.: 18/449,510

(22) Filed: Aug. 14, 2023

Related U.S. Application Data
(60) Provisional application No. 63/371,593, filed on Aug. 16, 2022.

(51) Int. Cl. H04L 65/80; G02B 27/01

(52) U.S. Cl. CPC H04L 65/80; G02B 27/017

(57) ABSTRACT

In an embodiment, a head mounted device (HMD) is configured to receive streamed virtual reality or augmented reality (VR/AR) data through a first connection and a second connection. The streamed VR/AR data is controlled by a controller that transmits first streamed VR/AR data from a data source to the HMD via the first connection and transmits second streamed VR/AR data from the data source to the HMD via the second connection such that the HMD receives a continuous stream of VR/AR data when the data source switches from transmitting the first streamed VR/AR data to transmitting the second streamed VR/AR data.

### CROSS-REFERENCE TO RELATED APPLICATIONS

This application claims priority to and the benefit of U.S. Provisional Application No. 63/371,593, entitled “WIRED AND WIRELESS SWITCHING FOR HEAD-MOUNTED DEVICE,” Aug. 16, 2022, which is hereby incorporated by reference in its entirety for all purposes.

### BACKGROUND

The subject matter disclosed herein relates generally to the field of virtual reality and/or augmented reality. More specifically, embodiments of the present disclosure relate to systems and methods utilized to transition between wired and wireless streaming configurations for transmitting data to head mounted devices (HMDs).

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Various amusement rides have been created to provide passengers with unique motion and visual experiences. For example, virtual reality and/or augmented reality systems may be used in conjunction with theme rides and can be implemented with multi-passenger vehicles that travel along a fixed path. Headwear such as a head-mounted device (HMD) may include a display and may be worn by a passenger to give the wearer the virtual reality and/or augmented reality experience. In certain cases, the head-mounted devices may be tethered via a cable to features of the amusement ride, such as the ride vehicle, which may prevent passenger mobility within the ride.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a data communication system for virtual reality or augmented reality data is provided. The system includes a head mounted device (HMD) configured to receive streamed virtual reality or augmented reality (VR/AR) data through a first connection and a second connection. The system also includes a controller comprising a memory storing instructions and a processor configured to execute the instructions. The instructions include instructions to transmit first streamed VR/AR data from a data source to the HMD via the first connection and transmit second streamed VR/AR data from the data source to the HMD via the second connection such that the HMD receives a continuous stream of VR/AR data when the data source switches from transmitting the first streamed VR/AR data to transmitting the second streamed VR/AR data.

In an embodiment, data communication system for virtual reality or augmented reality data is provided. The system includes a data source configured to transmit a first portion of a virtual reality or augmented reality (VR/AR) data stream through a wired connection and to transmit a second portion of the VR/AR data stream through a wireless connection. The system also includes a head mounted device (HMD) configured to receive the first portion of the VR/AR data stream via the wired connection and receive the second portion of the VR/AR data stream via the wireless connection, wherein the HMD is configured to transition from receiving the first portion of the VR/AR data stream to receiving the second portion of the VR/AR data stream. The system also includes a controller configured to generate a control signal to cause the data source to switch between the wired connection and the wireless connection.

In an embodiment, data communication method for virtual reality or augmented reality data is provided that includes steps of selectively transmitting, via a data source, first streamed virtual reality or augmented reality (VR/AR) data to a head mounted device (HMD) via a first connection and selectively transmitting, via the data source, second streamed VR/AR data to the HMD via a second connection such that the HMD receives a continuous stream of data when the data source switches from transmitting the first streamed VR/AR data to transmitting the second streamed VR/AR data.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a data communication system operating in a wireless operating mode and transmitting data from a data source to VR/AR equipment, shown as head-mounted devices (HMDs), according to embodiments of the present disclosure;

FIG. 2 is a schematic illustration of an arrangement of the data communication system with both wired and wireless data communication to HMDs from a data source, according to embodiments of the present disclosure;

FIG. 3 is a block diagram of the wireless data communication system, according to embodiments of the present disclosure;

FIG. 4 is a timing diagram of operations of the data communication system, according to embodiments of the present disclosure;

FIG. 5 is a timing diagram of operations of the data communication system, according to embodiments of the present disclosure; and

FIG. 6 is a diagram of operations of the data communication system, according to embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

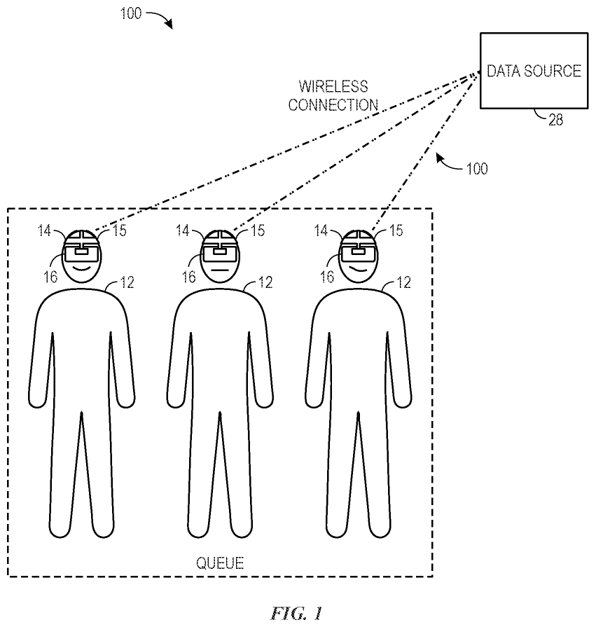

As an introduction, FIG. 1 is a schematic illustration of a data communication system 10 that may be used in conjunction with the disclosed techniques. In one example, an amusement park may incorporate VR/AR technology. In such cases, the amusement park may provide a head-mounted device (HMD) 14, or guests may bring their own device 14, that is able to communicate with an attraction controller or central controller to receive VR/AR data. The HMD 14, when worn by the guest 12, permits the guest 12 to view the received VR/AR data. Further, the HMD 14 may also communicate guest location information, other environmental information, or data quality information, back to the central controller. On an embodiment, the HMD 14 generates a data quality signal that provides information about data quality. If the data quality signal is indicative of streamed VR/AR data below a threshold, then the operating mode can switch from wired to wireless or vice versa.

In the illustrated example, the HMDs may be two-part or multi-part devices that include a guest interface 15 that is a lightweight device worn on the head of a guest 12 and an attachable display system 16. In one example, the guest interface device 15 may be a passive device that serves to removable attach the display system. The interface device 15 can be handed out in a queue 18 for the attraction, and the display system 16 can be attached to the interface device 15 to assemble the HMD 14. However, it should be understood that the HMD 14 may be unitary assembly in which the display system 16 that displays the VR/AR data is not detachable from a head or other interface component.

The HMD 14 may receive, via a wireless connection 20, VR/AR data from a data source 22. For example, the data source 22 may include memory device(s), processor(s), communication circuitry, and the like to perform operations such as streaming data to HMD 14, e.g., to the display systems 16, worn by guests 12 in the queue 18 or within the attraction. In some embodiments, the data may be stored in the memory device(s) of the data source. Additionally or alternatively, the data may be transmitted to the data source 22 from a controller of the amusement park, for example via the communication circuitry of the data source 22.

The data source 22 may transmit, via the wireless connections 20, data to the HMDs 14 associated with a riding experience. For example, guests 12 may wait in the queue 18 in preparation for entrance to a ride. In some embodiments, instructions may help prepare the guests 12 for a smooth transition into the riding experience. For example, the instructions may educate the guests 12 on where to enter a ride vehicle, how to secure themselves to the ride vehicle, and what they may expect to occur over the course of the ride. For example, if there are actions for the guest 12 to take during the course of the ride (e.g., a mini-game or other actions based on the ride), then the instructions may inform the guests 12 of how and when to take such actions. Providing these instructions to the guests 12 via the display systems 16 may provide a convenient method for distilling the instructions to all of the guests 12 before they enter the attraction. For example, instead of having an employee announce the instructions from a script, the instruction video data stored in the data source 22 or otherwise transmitted to the data source 22 may provide a more effective way of presenting the instructions. In an embodiment, graphics or examples shown via the display system 16 may facilitate dissemination of language-independent instructions to guests 12. The data source 22 may transmit other types of data to the display systems 16 of the HMDs 14. For example, mini-games associated with the pending ride or other attractions or features of the amusement park, advertisements, or the like may be presented to the guests 12 while in the queue 18.

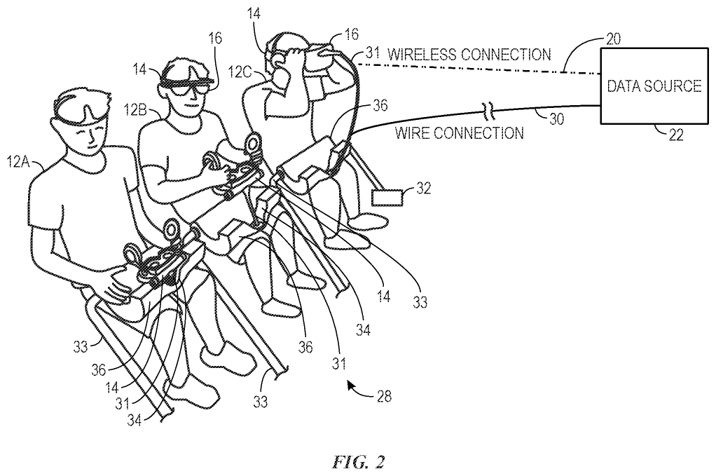

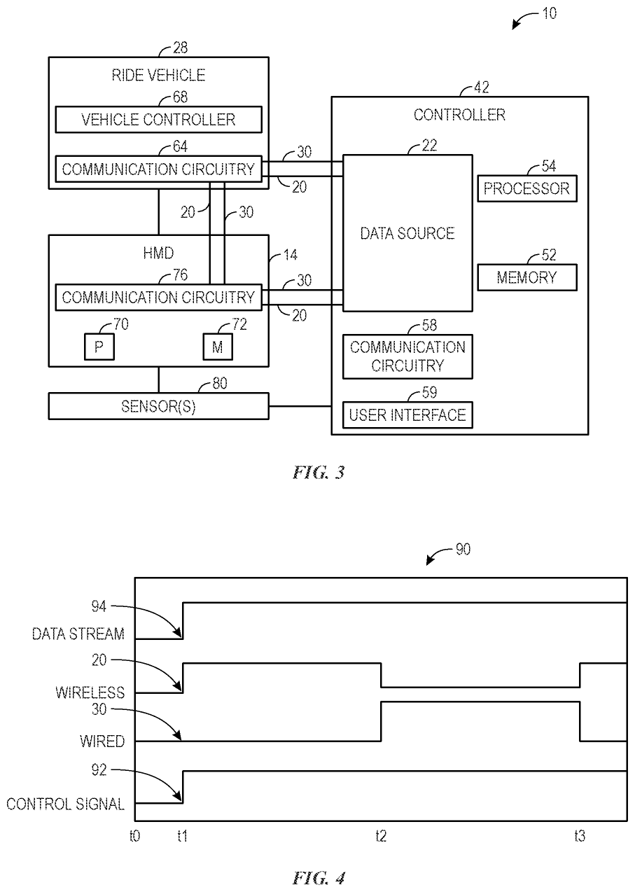

In embodiments, as generally discussed herein, the system 10 may facilitate dynamic switching to or from wireless communication with the HMDs 14 within the attraction based on various environmental or data transmission conditions of the attraction. For example, FIG. 2 is a schematic illustration of a dynamic communication pathway between the data source 22 and the HMDs 14 used in conjunction with an amusement ride vehicle 28 with guests 12 seated in the passenger vehicle 28. In some embodiments, the data source 22 may connect to the display systems 16 of the HMDs 14 worn by the guests 12 via wireless connections 20, as previously described. Further, in some embodiments, it may be desirable to have a wired connection 30 between the data source 22 and the display systems 16. Accordingly, in some embodiments, the data source 22 may physically connect to the display systems 16 via wired connections 30 for at least part of the data communication pathway. As discussed herein, the HMDs 14 may be implemented with wireless communication circuitry to facilitate wireless connections 20 and also include a tether or cable 31 to facilitate wired connections 30. Control of the communication pathway and switching between wired connections 30 and wireless connection 20 may be based on inputs to the system 10 and implemented by a controller (see FIG. 3). The cable 31 may additionally be used to transmit electrical signals and/or power to the display systems 16.

As depicted, the guests 12 are secured inside the passenger vehicle 28 with locking lap bars 33. The locking lap bars 33 have the display systems 16 secured inside cavities 34 suitable for storing the display systems 16 in the passenger vehicle 28. More specifically, the cavity 34 is disposed in a lap bar cummerbund 36. A guest 12A is shown as removing the display system 16 from the locking lap bar 33 to place the display system 16 on the interface device 15. It should be understood that the wireless and wired dynamic switching may be on a per-device basis in an embodiment. For example, the HMD 14 of the guest 12A may receive data through the wireless connection 20 while the HMDs 14 of the other guests, guest 12B and guest 12C, may receive data through the wired connection 30. The cables 31 may retract (e.g., via spring bias mechanism, electric motor assist, gravity assist, and so on) into respective locking lap bars 33. In certain cases, repeated retractions or manipulation may damage the cable 31. Upon detection of a faulty data communication to a particular HMD 14, which may be based on cable damage, the system 10 can initiate a wired-to-wireless switch so that the data communication switches from the wired connection 30 to the wireless connection 20. Wireless connections 20 may be less robust than wired connections 30 during operation of an amusement ride, particular through twisting sections with physical barriers to signal transmission. However, by defaulting to wired connections 30 and initiating switching to wireless connection 20 in the event of a detected signal quality issue on a per-device or per-vehicle basis, the number of wireless connections 20 is minimized, which in turn creates less possibility for signal interference and uses less bandwidth relative to solutions in which all HMDs 14 are switched to wireless.

In addition to dynamic switching based on signal quality or other environmental factors, the wired-to-wireless switching can be programmed based on known or predicted poor signal quality locations or ride environment changes. For example, the HMDs can be operated in wireless operating mode while the guests 12 are in a queue and moving about freely, but entering the ride vehicle 28 and connecting the cable 31 can activate an automatic switch to a wired operating mode using the wired connection 30. Once in the wired operating mode, the system 10 can maintain the wired connection 30 until a poor or reduced signal quality is detected or until the guests 12 exit the ride vehicle 28.

FIG. 3 is a block diagram of an embodiment of the data communication system 10 to facilitate control and switching between wired and wireless connections with an individual HMD 14 via a controller 42. While only a single HMD 14 is depicted, it should be understood that the controller 42 may be in communication with multiple HMDs 14 that can be individually addressed. The controller 42 may control additional system elements, such as the ride vehicle 28, in an embodiment. The controller 42 may include memory circuitry 52 and processing circuitry 54, such as a microprocessor. The controller 42 may also include the data source 22. In an embodiment, the data source 22 may be part of the memory 52 or may be a separate storage device, e.g., a memory stack. The processing circuitry 54 may be used to execute software, such as software stored on the memory circuitry 52, to control the ride vehicle(s) 28 and the HMDs 14 associated with the ride vehicle 28. Moreover, the processing circuitry 54 may include multiple microprocessors, one or more “general-purpose” microprocessors, one or more special-purpose microprocessors, and/or one or more application-specific integrated circuits (ASICs), or some combination thereof. For example, the processing circuitry 54 may include one or more reduced instruction set (RISC) processors.

The memory circuitry 52 may include a volatile memory, such as random-access memory (RAM), and/or a nonvolatile memory, such as read-only memory (ROM). The memory circuitry 52 may store a variety of information and may be used for various purposes. For example, the memory circuitry 52 may store processor-executable instructions (e.g., firmware or software) for the processing circuitry 54 to execute, such as instructions for controlling components of the ride system 10. The instructions, when executed by the processing circuitry 54, may cause the processing circuitry 54 to communicate. The storage device(s) (e.g., nonvolatile storage) may include ROM, flash memory, a hard drive, or any other suitable optical, magnetic, or solid-state storage medium, or a combination thereof. The storage device(s) may store additional data that can be communicated to the HMDs 14.

The controller 42 also includes communication circuitry 58 that can mediate communication over the wireless connection 20 and/or the wired connection 30. For example, the communication circuitry 58 may include a wireless transmitter and a wireless receiver, e.g., a transceiver. The communication circuitry 58 may additionally include an input port for the cable 31. In embodiments, the communication circuitry 58 may be arranged such that both the wired connection 30 and the wireless connection 20 between the data source 22 and an individual HMD 14 can occur simultaneously or can occur with one type of communication at a given time. The controller 42 may also include a user interface 59 to receive operator input.

In embodiments, the wired and/or wireless connection may include communication via the ride vehicle 28. The ride vehicle 28 may include communication circuitry 64 to support the wireless connection 20, e.g., the transceiver 32 (see FIG. 2), and/or a cable 31 and/or port to support the wired connection 30. Control of the ride vehicle communication circuitry 64 may be under control of a vehicle controller 68, which may include certain elements such as a processor and memory, as generally discussed with respect to the controller 42. Further, the individual HMD 14 may include a processor 70, a memory 72, and integral communication circuitry 76, e.g., one or more communication components, that supports the wireless connection 20 and the wired connection 30. For example, the HMD 14 may include a transceiver that supports the wireless connection 20 and a cable input port that supports the wired connection 30.

The communications circuitry 76 may include antennas, radio transceiver circuits, and signal processing hardware and/or software (e.g., hardware or software filters, A/D converters, multiplexers amplifiers), or a combination thereof, and that may be configured to communicate over wireless communication paths via IR wireless communication, Wi-Fi, satellite communication, broadcast radio, microwave radio, Bluetooth, Zigbee etc. The communications circuitry 76 may be configured for connection with hardwired LAN networks. The communications circuitry 76 may include ports for wired connection via cable connections, such as an HDMI port or display port.

As provided herein, switching between a wired and wireless connection may refer to communication in a final or last leg of the communication pathway or may refer to communication along an entire pathway. That is, even in a wired connection 30, part of the communication pathway may nonetheless be wireless, e.g., between the data source 22 and a local transceiver 32 or between the data source 22 and a controller. In an embodiment, all or part of the data source 22 may be located on the vehicle 28, and the communication may include wireless communication between a controller and the data source 22 that causes the data source 22 to receive the data and, in turn, transmit VR/AR data over the wired connection 30 or the wireless connection 20. In one embodiment, the data source 22 may be integrated into a control system of the passenger vehicle 28.

In other embodiments, the communication circuitry 64 of the ride vehicle 28 may include the transceiver 32 (see FIG. 2) that communicates with the data source 22 and that receives and, in some cases, stores data from the data source 22. By offloading the transceiver 32 from being positioned on the HMDs 14, the HMDs 14 may be implemented with smaller, lighter communication circuitry that can facilitate wireless connections 20 when conditions are favorable based on the guest location in the attraction and/or the data communication conditions. When conditions are less favorable, the HMDs 14 can be operated using the wired connections 30. The transceiver 32 can act as a bridge for data communication from the data source 22 using more complex or powerful communication circuitry relative to the HMDs 14.

Thus, in an embodiment, a wireless connection 20 may refer to a direct wireless transmission between an individual HMD 14 and the data source 22. The wireless connection 20 may be a wireless transmission from the data source 22 to the transceiver 32 and, in turn, a wired or wireless transmission from the communication circuitry 64 to the individual HMD 14. The wired connection 30 may refer to a direct wired connection between the data source 22 and an individual HMD 14 via the cable 31. In an embodiment, the wired connection 30 may refer to a wireless transmission from the data source 22 to a pass-through device on the ride vehicle 28. The ride vehicle 28 may also include a memory that stores the data from the data source 22.

As discussed herein the wired to wireless, and vice versa, switching can be pre-programmed to coincide with certain ride events. In addition, the switching may be based on one or more sensor signals, e.g., from a sensor 80. The sensor 80 may be part of the HMD 14, part of the ride vehicle 28, and/or an environmental sensor. In an embodiment, the switching is based on signal quality assessment, which can be performed by the controller 42 or the HMD 14. For example, the HMD 14 can detect on-board data deterioration and send a signal to the controller 42. The controller 42 can switch the operating mode of the HMD 14 to wired form wireless or vice versa. The controller 42 can also identify wireless communication failures with individual HMDs 14 and instruct those particular HMDs to initiate wired connections 30 in response.

FIG. 4 illustrates a time graph 90 of an example set of operations of the data source 22 and under control of a control signal 92. Occasionally, switching between wired communications and wireless communications may require the power of a data streaming device to be reset. However, the data source 22 may alternate between streaming data via wireless connections 20 and wired connections 30 while maintaining a continuous stream of data. For example, at a time t0, a control signal 92 of the data source 22 may be off and/or transmission of a data stream to a particular HMD 14 by the data source 22 may be inactive based on the control signal 92.

At a time t1, the data source 22 may be activated for example based on the control signal 92 provided by the controller 42. For example, the control signal 92 may be generated by activation of a ride cycle. At the time t1, the data stream 94 of VR/AR data may be sent from the data source 22 to connected display systems 16 of the HMD 14 via either a wireless connection 20 or a wired connection 30. For example, in the illustrated time graph, at t1, the display systems 16 associated with a given passenger ride vehicle 28 or queue 18 are connected to the data source 22 via wireless connections 20. For example, the time t1 may indicate when a guest 12 attaches a display system 16 to their interface device 15 (e.g., in the ride vehicle 28 or in the queue 18). At the time t1, the data stream 94 may be transmitted to the display systems 16 via the wireless connections 20. For example, in an embodiment where the t1 indicates when a guest 12 enters the queue 18 and attaches a display system 16 to their interface device 15, instructions/mini-games/advertisements/etc. may be streamed to the display system 16. Further, in an embodiment when the time t1 indicates when a ride has begun, the data stream 94 may include VR/AR data associated with the ride. This may continue until a time t2, wherein the connection between the data source 22 and one or more of the displays systems 16 transitions from the wireless connection 20 to the wired connection 30. For example, this may be accomplished by coupling the cable 31 to the display system 16 as previously discussed.

There may be many reasons for a guest 12 to switch from the wireless connection 20 to the wired connection 30. For example, in some embodiments, the wired connection 30 may be faster, less prone to data lag, more reliable, or the like. At the time t2, the guest 12 may have experienced faulty or otherwise unreliable transmissions of the data stream 94 via the wireless connection 20, and may couple the cable 31 to the display system 16 to allow the wired connection 30 to transmit the data stream 94 to the display system 16. Further, in some embodiments, the wired connection 30 may be initiated by the passenger ride vehicle 28 or other individual or machine. For example, prior to the beginning of a ride, or at any other time when the wired connection 30 may be preferable to the wireless connection 20 (e.g., at certain points over the course of the ride), the cable 31 may be automatically or manually coupled to one or more display systems 16. For example, in some embodiments, a robotic feature of the passenger vehicle 28 may couple the cable 31 to the display systems 16. Additionally or alternatively, in some embodiments, the guests 12, an operator of the ride, or the like may couple the cable 31 to the display systems 16.

The transition at t2 from the wireless connection 20 to the wired connection 30 may be seamless, such that the data stream 94 is continuously transmitted to the display system 16 and the guest 12 may not observe or experience any disruption to the VR/AR data from the data stream 94. In some embodiments, software in the data source 22 may be used, as will be described herein, to mask any delays caused by transitioning from the wireless connection 20 to the wired connection 30.

At a time t3, the data source 22 may transition again from sending the data stream 94 via the wired connection 30 to sending the data stream 94 via the wireless connection 20. In some embodiments, the time t3 may be triggered by the decoupling of the cable 31 from the display system 16. Additionally or alternatively, the time t3 may indicate an end of a riding experience, or other similar time where the wireless connection 20 may be preferable to the wired connection 30. For example, during a dark portion of a riding experience, the wireless connection 20 may struggle to reliably transmit the data stream 94. Once the dark portion of the riding experience is complete (i.e., at the time t3), it may desirable to resume wireless communications between the data source 22 and the display systems 16.

In some embodiments, a riding experience may include a period of time where guests 12 may move around freely, for example, within the passenger vehicle 28 or outside the passenger vehicle 28 momentarily. Accordingly, during this time (e.g., the time t1) the display systems 16 of the guests 12 may receive the data stream 94 via wireless connections 20 to the data source 22. The time t2 may indicate a time where movement is restricted, and so the guests 12 may couple the cable 31 to their respective display system 16 to continue the ride. Further, there may be other situations or experiences other than those disclosed that may utilize the operations described in the time graph 90.

Further, in some embodiments, the time t1 may be associated with guests 12 entering the queue 18. Upon entering the queue 18 and attaching the display systems to the interface devices 14, the guests 12 may begin receiving the data stream 94 from the data source 22 via the wireless connection 20. For example, while in the queue 18, the data stream 94 may include broadcasted, generic data (e.g., advertisements, mini-games, instructions, etc.). The time t2 may indicate the start of a riding experience, wherein the guests 12 may enter the passenger vehicle 28 and couple the cable 31 to their respective display systems 16. Further, although the time graph 90 discloses the time t1 as being associated with the wireless connection 20, the time t2 as being associated with the wired connection 30, and the time t3 as being associated with the wireless connection 20, any combination or order of transitions between the wireless connections 20 and the wired connections 30 may be used.

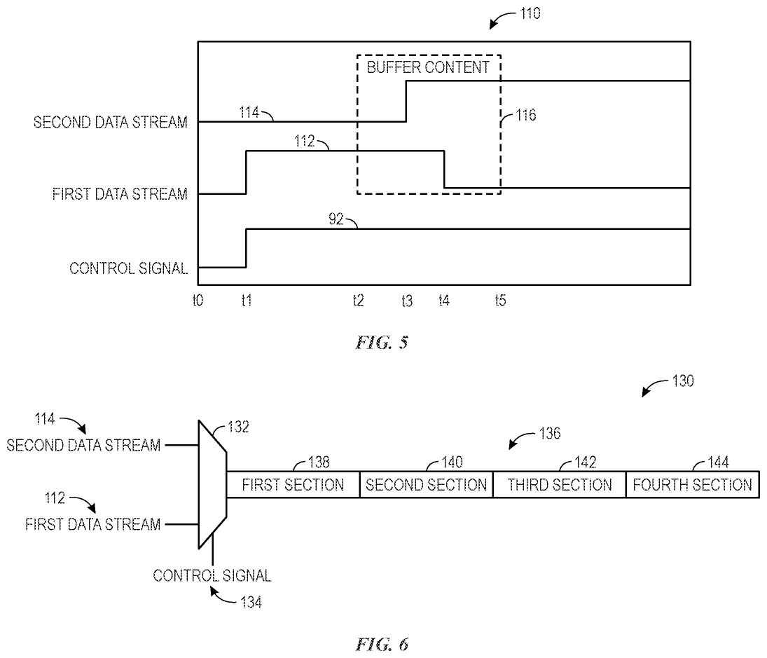

FIG. 5 illustrates a time graph 110 showing further operations of the data source 22. For example, in some embodiments, the data source 22 may be connected to one or more display systems 16 via both wireless connections 20 and wired connections 30. However, in some instances, it may be more advantageous to stream data from one of the connections than from the other. For example, in some embodiments, the wireless connection 20 may not have enough bandwidth to support individualized streamed data to a number of display systems 16. Indeed, the wireless connection 20 may be better utilized for streaming generic data, as previously described. Further, the wired connections 30 may have the bandwidth to provide individual data streams to several (e.g., each) of the connected display systems 16. Accordingly, the wireless connections 20 and the wired connections 30 may be selectively used according to the type of data that is to be streamed, even when the wireless connections 20 and the wired connections 30 are both connected to display systems 16.

To illustrate this, the time graph 110 describes operations of the data source 22 when the data source 22 is connected to display systems 16 via both wireless connections 20 and wired connections 30. For example, some or all of the connected display systems 16 may be connected to the data source 22 via both a wireless connection 20 and a wired connection 30. At a time t0, the control signal 92 of the data source 22 may be off. Accordingly, first streamed data 112 sent from the data source 22 to the connected display systems 16 via the wireless connections 20 of the data source 22 and second streamed data 114 sent from the data source 22 to the connected display systems 16 via the wired connections 30 may both be disabled. Further, it should be noted that in some embodiments, the first streamed data 112 may be from wired connections 30, and the second streamed data 114 may be from wireless connections 20.

At a time t1, the control signal 92 may be turned on, and data may be transmitted from the data source 22 to the connected display systems 16. For example, the first data stream 112 may be activated, and the first data stream 112 may be streamed to the display systems 16 via the wireless connections 20. In some embodiments, buffer content 116 may be streamed via both the first data stream 112 and the second data stream 114 to mask any disruptions or discontinuities that may be caused by transitioning between streaming data via the wireless connection 20 and streaming data via the wired connection 30, or vice versa. Accordingly, at a time t2, the first data stream 112 (e.g., from the wireless connections 20) may begin streaming the buffer content. Further, at a time t3, the data source 22 may begin streaming the second data stream 114 to the connected display systems 16 via the wired connections 30. In some embodiments, the wireless connections 20 and the wired connections 30 may both stream data to the same display systems 16 at the same time. For example, during a transitionary period before one of the wireless connections 20 and wired connections 30 ceases transmitting data, both may stream data concurrently.

At a time t4, the first data stream 112 (e.g., from the wireless connections 20) may be disabled, and the connected display systems 16 may exclusively receive the buffer content 116 from the second data stream 114 (e.g., via the wired connections 30). Further, at a time t5, once any potential disruptions from transitioning between streaming data from the wireless connections 20 to the wired connections 30 have are past, the buffer content 116 may cease being streamed by the second data stream 114. Accordingly, the second data stream 114 may stream other data sent by the data source 22.

In some embodiments, the buffer content 116 may be played by the first data stream 112 and the second data stream 114 at any time. For example, in addition to being streamed during a transition between the first data stream 112 and the second data stream 114, in some embodiments, the buffer content 116 may be streamed to mask any disruption in the first and second data streams 112 and 114. Further, in some embodiments, the buffer content 116 may be sent on a per-display system 16 basis. For example, the buffer content 116 may selectively be streamed to display systems 16 that have faulty or weak connections to the data source 22. Further, although the time graph 110 illustrates the first data stream 112 being activated at the time t1 and the second data stream 114 being activated at the time t3, other timings may occur. For example, in some embodiments, the wired connections 30 may stream the first data stream 112 instead of the wireless connections 20. Indeed, the illustrated example shown in the time graph 110 is not intended to be limiting.

Turning now to FIG. 6, in some embodiments, the data source 22 may time multiplex the first data stream 112 and the second data stream 114. For example, in some embodiments, it may be desirable to pre-program transitions between streaming VR/AR data from wireless connections 20 and from the wired connections 30. For example, a given ride of the amusement park may have moments where guests 12 may freely move, and would preferably be streamed VR/AR data wirelessly. Further, the given ride may have moments where the environment is dark, or otherwise not conducive for wireless connections 20. Accordingly, under such circumstances the data transmitted to the display systems 16 may be via the wired connections 30. Additionally or alternatively, in some embodiments, the data source 22 may uniquely tailor the time multiplexed signals for a given display 16, rather than for all of the display systems 16 associated with a given ride.

Accordingly, FIG. 6 illustrates a diagram 130 of multiplexing operations of the data source 22. The data source 22 may include a multiplexer 132 to receive the first data stream 112 for a given display system 16 (e.g., via a wireless connection 20) and the second data stream 114 for the given display system 16 (e.g., via a wired connection 30). The multiplexer 132 may further receive a control signal 134 to determine how the first data stream 112 and the second data stream 114 should be output to the given display system 16. For example, the control signal 134 may be sent to the data source 22 from a controller of the ride or queue associated with the data source 22. Further, data from the control signal 134 may be received by communication circuitry of the data source 22 and may be stored in the memory device(s) of the data source 22. In some embodiments, the control signal 134 may be based on the VR/AR experience associated with a ride. For example, if certain VR/AR data is more efficiently transmitted via wired connections 30, then the control signal 134 may indicate when the data source 22 should stream via wired connections 30. As an illustrative example, the multiplexer 132 may output a first section of data 138 at a first time based on the control signal 134. In some embodiments, the first section of data 138 may be sent via the first data stream 112. Further, the multiplexer 132 may output a second section of data 140 including the second data stream 114 at a second time. The multiplexer may then, at a third and a fourth time, output a third section of data 142 including the first data stream 112 followed by a fourth section of data 144 including the second data stream 114. However, the described order and content of data streaming is not intended to be limiting. Indeed, in some embodiments, any arrangement of data may be output to generate a data stream 136 including portions in any order based on the control signal 134.

Further, in some embodiments, the multiplexer 132, or other circuitry of the data source 22, may be configured to employ frequency division multiplexing techniques to transmit unique signals to a number of connected display systems 16. For example, in some embodiments, the control signal 134 may assign a unique frequency for each of the connected display systems 16. The data source 22 may stream data to the connected display systems 16 according to the frequencies established by the control signal 134. Further, in some embodiments, the first data stream 112 and the second data stream 114 may also be multiplexed using frequency division techniques. For example, the control signal 134 may indicate a specific frequency for the first data stream 112 and a different, unique frequency for the second data stream 114. As such, the data source 22 may stream both the first data stream 112 and the second data stream 114 to connected display systems 16 concurrently. In some embodiments, the display systems 16 may be tuned to selectively display streamed data from a specific frequency range. For example, there may be additional knobs or other switching mechanisms on the display systems 16 to allow the guests 12 to select whether to stream the first data stream 112 or the second data stream 114.

For example, in some embodiments, a single ride may have two or more VR/AR experiences associated with it. Accordingly, the first data stream 112 may stream a first VR/AR experience and the second data stream 114 may stream a second VR/AR experience. As discussed previously, in some embodiments, the first data stream 112 may be transferred via wireless connections 20, and the second data stream 114 may be transferred via wired connections 30. Additionally or alternatively, the first data stream 112 and the second data stream 114 may both be streamed from either a wireless connection 20 or a wired connection 30. The time and frequency division multiplexing techniques described may allow such streaming features. Further, these techniques may be scaled to any appropriate number of data streams. For example, the may be 1, 2, 3, 4, 5, 6, 7, 8, 9, 10, 20, 30, or the like different data streams that may be streamed from the data source. Indeed, in some embodiments, there may be a unique data stream for each connected display system 16, such that each guest 12 on a given ride may have a unique VR/AR experience tailored to them. For example, the age, interests, or other characteristic of the guests 12 may factor into the determination of what VR\AR experience the guests 12 receive. Further, in some embodiments, the guests 12 may have the option of selecting which VR/AR experience they want to have on a given ride. There may be selection mechanisms on the display systems 16 to enable this selection.

While only certain features have been illustrated and described herein, many modifications and changes will occur to those skilled in the art. It is, therefore, to be understood that the appended claims are intended to cover all such modifications and changes as fall within the true spirit of the disclosed embodiments.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A data communication system for virtual reality or augmented reality data, comprising:
a head mounted device (HMD) configured to receive streamed virtual reality or augmented reality (VR/AR) data through a first connection and a second connection; and
a controller comprising a memory storing instructions and a processor configured to execute the instructions to:
transmit first streamed VR/AR data from a data source to the HMD via the first connection; and
transmit second streamed VR/AR data from the data source to the HMD via the second connection,
wherein the HMD receives a continuous stream of VR/AR data when the data source switches from transmitting the first streamed VR/AR data to transmitting the second streamed VR/AR data.

2. The system of claim 1, wherein the data source is configured to receive a control signal to switch from the first streamed VR/AR data to the second streamed VR/AR data.

3. The system of claim 1, wherein the VR/AR data is associated with a VR/AR-compatible ride or queue of an amusement park.

4. The system of claim 1, wherein the data source is configured to transmit the first streamed VR/AR data and the second streamed VR/AR data to the HMD at the same time.

5. The system of claim 4, wherein the data source is configured to transmit the first streamed VR/AR data at a first frequency and the second streamed VR/AR data at a second frequency.

6. The system of claim 1, wherein the data source is configured to switch between streaming the first streamed VR/AR data to the HMD via the first connection and streaming the second streamed VR/AR data to the HMD via the second connection based on a data quality signal of the first streamed VR/AR data or the second streamed VR/AR data.

7. The system of claim 6, wherein the first streamed VR/AR data and the second streamed VR/AR data is buffer content while the data source is switching between streaming the first streamed VR/AR data and the second streamed VR/AR data.

8. The system of claim 1, wherein the first connection is a wireless connection and the second connection is a wired connection.

9. A data communication system for virtual reality or augmented reality data, comprising:
a data source configured to transmit a first portion of a virtual reality or augmented reality (VR/AR) data stream through a wired connection and to transmit a second portion of the VR/AR data stream through a wireless connection;
a head mounted device (HMD) configured to:
receive the first portion of the VR/AR data stream via the wired connection; and
receive the second portion of the VR/AR data stream via the wireless connection, wherein the HMD is configured to transition from receiving the first portion of the VR/AR data stream to receiving the second portion of the VR/AR data stream; and
a controller configured to generate a control signal to cause the data source to switch between the wired connection and the wireless connection.

10. The system of claim 9, wherein the data source transmits a third portion of the VR/AR data stream at a same time as the first portion or the second portion.

11. The system of claim 10, wherein the HMD is configured to display either the first portion or the second portion at a given time.

12. The system of claim 10, wherein the HMD is configured to store the third portion in a memory of the HMD.

13. The system of claim 12, wherein the third portion comprises buffer content that is displayed upon identification of a discontinuity in data streaming of the first portion or the second portion.

14. The system of claim 9, wherein the wired connection is via a removable cable.

15. The system of claim 9, wherein the HMD is configured to transition from receiving the first portion to receiving the second portion responsive to identification of poor signal quality of the wired connection.

16. A data communication method for virtual reality or augmented reality data, the method comprising:
selectively transmitting, via a data source, first streamed virtual reality or augmented reality (VR/AR) data to a head mounted device (HMD) via a first connection; and
selectively transmitting, via the data source, second streamed VR/AR data to the HMD via a second connection,
wherein the HMD receives a continuous stream of data when the data source switches from transmitting the first streamed VR/AR data to transmitting the second streamed VR/AR data.

17. The method of claim 16, further comprising generating a control signal that controls switching of the data source.

18. The method of claim 17, wherein the control signal is generated based on a reduction of data quality of the first streamed VR/AR data.

19. The method of claim 16, wherein the first streamed VR/AR data is streamed at a first frequency and the second streamed VR/AR data is streamed at a second frequency.

20. The method of claim 19, further comprising displaying, by the HMD, the first streamed VR/AR data or the second streamed VR/AR data, based on a frequency setting of the HMD.
